(19) United States
(12) Patent Application Publication
(10) Pub. No.: US 2003/0136741 A1
(43) Pub. Date: Jul. 24, 2003

(54) Chemical and process for removing emulsions from waste water

(76) Inventors: Kevin Xie, South El Monte, CA (US); Dominic K. Lau, South El Monte, CA (US); Ding-Yuan Fei, South El Monte, CA (US)

Correspondence Address: ALBERT O COTA, 5460 WHITE OAK AVE, SUITE A-331, ENCINO, CA, 91316, US

(21) Appl. No.: 10/054,190

(22) Filed: Jan. 24, 2002

(51) Int. Cl. C02F 1/52

(52) U.S. Cl. 210/708

(57) ABSTRACT

A process for removing an oil-in-water emulsion from waste water. The process consists of collecting the emulsion waste water, adding a precipitation reagent with trivalent cations, and adding a base compound to adjust the pH of the waste water. The adjusted waste water converts the dissolved trivalent cations to gelatinous cation hydroxide precipitations and separate the emulsion from the waste water. The process can be enhanced by also utilizing a filtration means to further separate the precipitation from the waste water. The process is designed to reduce the level of the emulsion from 1000 ppm to less than 1 ppm.

### TECHNICAL FIELD

The invention pertains to the general field of waste water treatment processes and, more particularly, to a process for removing an oil-in-water emulsion from waste water.

### BACKGROUND ART

An oil-in-water emulsion is a solution consisting of small oil particles that are evenly dispersed in water. The emulsion can be stabilized by adding surfactant compounds, which bridge nonpolar oil and polar oil water phases. One method of treating waste that is created by the emulsion is to break up the emulsion's state using a de-emulsifier. The de-emulsifier utilizes chemicals which separate the oil-in-water emulsion into an oil phase and a water phase, thus allowing both the oil and the water to be recycled.

A disadvantage of breaking up an emulsion is that some relatively high water soluble compounds, which were originally in the oil particles, may be re-distributed to the water phase. Additional treatment is then required if the concentration of the water soluble compounds exceeds a pre-imposed discharge limit.

One example in which waste water is generated is during the manufacturing of propofol injectable. Propofol is chemically described as 2,6-Diisopropylphenol (CAS registration number 2078-54-8) and has been widely used as anesthesia. Propofol injectable is formulated in a white, oil-in-water emulsion. The final concentration of propofol injectable that pharmaceutical companies make is 1%. In addition to the active component propofol, the formulation also contains 10% soybean oil, 2.25% glycerol, 1.2% egg lecithin and 0.005% disodium edetate with sodium hydroxide to adjust pH to 7-8.5.

The waste water generated during the manufacturing of propofol injectable contains while emulsion of propofol, soybean oil, glycerol, egg lecithin and a small amount of disodium edetate. Since propofol is a phenolic compound, and soybean oil belongs to oil waste, their discharge in the United States is regulated by a governmental agency. For many cities in the U.S., the permissible discharge limit for phenolic compounds is 0.5 mg/L, and for oil is 375 mg/L. Since the concentrations of propofol and soybean oil are more than 10,000 times higher than the discharge limits, the waste water generated during pharmaceutical production of propofol injectable requires treatment to remove or reduce propofol and soybean oil from the waste water before being discharged into a sewage system.

Propofol is a very stable phenolic compound. Stress tests have shown no detectable degradation when 3% propofol is refluxed for 2 hours in IN HCI solution, or refluxed for 2 hours in 7% H₂O₂ solution, or under 3 hours of UV radiation at 254 nm. Therefore, it is difficult to chemically destroy propofol emulsion. If a de-emulsifier is added to the waste, propofol molecules originally wrapped by lecithin will be released into the water phase, thus resulting in a propofol-saturated water phase that is higher than the discharge limit.

A search of the prior art did not disclose any patents that read directly on the claims of the instant invention, however the following U.S. patents are considered related:

| U.S. Pat. No. | INVENTOR | ISSUED |
|---|---|---|
| 4,160,742 | Raman | Jul. 10, 1979 |
| 4,075,183 | Kawakami, et al | Feb. 21, 1978 |
| 3,956,117 | Bradley, et al | May 11. 1976 |

The U.S. Pat. No. 4,160,742 patent discloses the use of copolymer of acrylamide and methlacrylamidopropytri-methylammonium chloride to de-emulsify oil-in-water emulsions especially in waste streams prior to their discharge from petroleum refineries, industrial plants and the like.

The U.S. Pat. No. 4,075,183 patent discloses a water-soluble, cationic high polymer consisting of (A) at least one of acrylamide and methacrylamide and (B) at least one of ammonium type monomers of either one of the formulas: ##STR1## wherein R.sub.1 is a hydrogen atom or a methyl group, R.sub.2 and R.sub.3 are each a lower alkyl group, R.sub.4 is a hydrogen atom, a lower alkyl group, an aryl group, a hydroxy (lower) alkyl group, a benzyl group or a group of the formulas: CH.sub.2 COO(CH.sub.2).sub.m CH.sub.3 (m being an integer of 0 or 1), R.sub.5.sup.- is a group of either one of the formulas: —(CH.sub.2).sub.2 COO.sup.- and —(CH.sub.2).sub.3 SO.sub.3.sup.-, X is a halogen atom or an acid residue, Y is —O— or —NH— and n is an integer of 1 to 4, a process which initiates the polymerization of the monomeric component (A) with or without a portion of the monomeric component (B) in an aqueous medium containing an organic solvent selected from the group consisting of acetone, acetonitrile, t-butanol, tetrahydrofuran and dioxane at a concentration of about 15 to 70% by weight until the polymerization proceeds to a certain extent and then continuing the polymerization while adding the remaining portion of the monomeric component (B) thereto under the occasional supplementation of a water-miscible organic solvent thereto so as to keep an appropriate viscosity of the reaction system to produce the high polymer in a high yield with ease.

The U.S. Pat. No. 3,956,117 patent discloses a method of breaking oil-in-water emulsions involving treating such oil-in-water emulsions with a polycationic water-soluble condensation copolymer. Treatment with the copolymer transforms the emulsified oil particles into flocs which may be directly removed or which may be removed after the addition of one or more flocculants.

### DISCLOSURE OF THE INVENTION

A process of removing an oil-in-water emulsion from waste water that results form the production of a water-based product, the process comprising the following steps:

a) collect the emulsion waste water in a container,

b) add a quantity of a precipitation reagent with trivalent cations, and

c) add a quantity of a base compound to adjust the pH of the waste water to approximately 6.5, which converts the dissolved trivalent cations to gelatinous cation hydroxide precipitation and separates the emulsion from the waste water.

To refine the above process, the precipitation can be separated from the waste water by utilizing a filtration means. The filtration means can consist of several processes including: vacuum filtration, positive pressure filtration, or by using a centrifuge.

By using the above process, the level of an emulsion can be reduced from 1000 ppm or above to less than 1 ppm.

In view of the above disclosure, the primary object of the invention is to provide a process by which waste water containing an oil-in-water emulsion may be treated to remove the emulsion, thus allowing proper disposal of the waste water.

It is also an object of the invention to:

provide a waste water treatment process that can be utilized to treat different types of substances containing an oil-in-water emulsion,

provide a waste water treatment method is quickly and easily performed,

allow the amounts of certain chemicals within waste water to be determined, and

provide a process by which a person/corporation who manufacture products having waste water can dispose of the waste water according to government-specified levels.

These and other objects and advantages of the present invention will become apparent from the subsequent detailed description of the preferred embodiment and the appended claims taken in conjunction with the accompanying drawings.

### BEST MODE FOR CARRYING OUT THE INVENTION

The best mode for carrying out the invention is presented in terms of a preferred embodiment for preparing (treating) waste water containing oil-in-water emulsion for disposal. The amount of oil-in-water emulsion that can be discharged during disposal without treatment is regulated by most United States city's municipal water districts. Typically, the permissible discharge limit for a phenolic compound is 0.5 mg/L, and for oil it is 375 mg/L. Since the concentrations of certain products, such as Propofol injectable and soybean oil, are more than 10,000 times higher than the discharge limits allowed, the waste water created during manufacture must be treated prior to disposal.

In order to treat the waste water/emulsion solution, (hereinafter “WWES”), the instant invention utilizes an aluminum hydroxide co-precipitation method. In this method a specified amount of a precipitation reagent having trivalent compounds, such as potassium aluminum sulfate (KAI(SO₄)₂), aluminum chloride or ferric chloride is added along with a determined amount of a base compound, such as sodium bicarbonate (NaHCO₃), sodium carbonate, ammonia or sodium hydroxide. The base compound is used to adjust the pH level, precipitation is generated within the WWES. (Note: for the purpose of this description, the precipitation reagent having trivalent compounds will be referred to throughout the text as potassium aluminum sulfate). The precipitation then brings down suspended oily particles (the “emulsion”). Thus, molecules that were originally wrapped in the oily particles are retained in the sediments, rather than distributed between oil and water phases according to their solubilities in both phases.

In order to use the invention, the following process is utilized:

A specified amount of potassium aluminum sulfate (KAl(SO₄)₂) is added to a container having an amount of WWES within. The potassium aluminum sulfate changes the pH of the WWES from neutral to about 3.5. The pH is then adjusted to approximately 6.5 by adding the base compound. As the pH increases, dissolved aluminum ions hydrolyse to form gelatinous aluminum hydroxide (Al(OH)₃) precipitate. The gelatinous aluminum hydroxide (Al(OH)₃) precipitate slowly settles to the bottom of the container, taking the suspended emulsions with it, thus creating a clear water phase and a settlement phase. The clear water is then separated from the settlement by a filtration means, that can consist of vacuum filtration, positive pressure filtration, a centrifuge, or by utilizing a filter paper, such as a No. 6 Whatman filter paper. In order to facilitate a complete phase separation in certain products, an activated carbon layer is used with the filter paper which is typically comprised with a #6 Whatman paper.

In order to disclose a complete description and the use of the invention, the following examples are given:

Example #1, treatment of 1% Propofol injectable

Example #2, treatment of diluted Propofol injectable,

Results of Examples #1 and #2

Example #3, regular Milk

Example #4, reduced fat milk

Example #5, fat free milk

Example #6, soy milk

Example #7, Ensure® nutrition drink produced by Ross Products Division, Abbott Laboratories, Columbus, Oh. 43215

### EXAMPLE 1

Treatment of 1% Propofol Injectable

To a solution of 1% Propofol injectable, add 5% (by weight) of potassium aluminum sulfate, hereinafter KAl(SO₄)₂. For example, 5 grams of KAl(SO₄)₂ should be added to 100 grams of 1% Propofol injectable solution. Once the KAl(SO₄)₂ has been completely dissolved, the pH of the solution will be approximately 3.5.

While stirring the solution, slowly add solid sodium bicarbonate (NaHCO₃) until the pH rises to 6.5. The amount of sodium bicarbonate needed to achieve the designated pH is about 3-5% weight of the solution. Since sodium bicarbonate is a weak base, the pH of the solution won't be greater than 7, even if more than 5% of sodium bicarbonate is used.

As the pH of the solution increases, the dissolved aluminum ions (Al⁺³) start to precipitate as a form of glutinous aluminum hydroxide (Al(OH)₃). The aluminum hydroxide also absorbs the emulsion in the solution while precipitating, thus resulting in phase separation of clear water at the top and white precipitation at the bottom. It should be noted that due to the generation of carbon dioxide, the precipitation first is on the top layer. If it is left standing overnight, all precipitation will be settled at the bottom layer.

The addition of sodium bicarbonate generates carbon dioxide bubbles, and care should be taken to add sodium bicarbonate slowly while stirring. Gradual addition of sodium bicarbonate avoids a sudden pH charge, which may cause the emulsion to break up. This will release free propofol molecules which cannot be absorbed by aluminum hydroxide precipitate, which is the main reason for using a weak base reagent of sodium bicarbonate, as opposed to stronger pH adjustment reagents such as ammonia or sodium hydroxide.

### EXAMPLE 2

Treatment of Diluted Propofol Injectable

Tests have been performed on 5 times and 10 times diluted 1% Propofol injectable. Results indicated that the amount of KAl(SO₄)₂ should be no less than 2% of the weight of the diluted propofol solution to achieve best results. The rest of procedures are the same as in Example 1.

One of the most critical steps during the treatment process described in Examples 1 and 2 is filtration. To achieve the best filtration, a layer of activated carbon is layed out on the No. 6 Whatman filter paper. To speed up the filtration process, a vacuum is generated at the bottom of the filter paper using a water pump. Activated carbon prevents small particles from passing through the filter paper, thereby resulting in clear filtrate with a turbidity of 2-12 NTU. By comparing the turbidity of 1% propofol injectable at about 150,000 NTU, it can be seen that the turbidity is reduced by more than 10,000 times. One draw back of using activated carbon is that is prolongs the filtration process. Other filtration methods may also be used as long as they possess similar filtering capabilities.

There are two reasons that can cause the resultant filtrate to be cloudy. One is due to incomplete filtration. Tests show that propofol content in a cloudy, incomplete filtration is approximately 0.5 mg/L. A second filtration process can be used to further reduce the phenolic level to about 0.1 mg/L.

The second reason is due to a break down of the emulsion. Some propofol molecules initially wrapped by lecithin are now in a free state. If this is the reason for the cloudy filtration, a second filtration will be useless to reduce phenolics level. One indication that the emulsion is being broken is that some oil should be visible on the top of the filtrate. Tests show that propofol content in the filtrate with oil on top can be approximately 1.0 mg/L.

Results of the Treatment

Environmental Protection Agency (EPA) standard method 420.1 was used to measure total phenolics. Phenolic concentrations in the treated clear filtrates are then less than 0.1 mg/L regardless if the starting solution was diluted propofol injectable or undiluted propofol injectable.

EPA standard method 410.4 was used to measure Chemical Oxygen Demand (COD). Results of clear filtrate (phenolics less than 0.1 mg/L) are approximately 3000-6900 mg/L. The COD level of 1% propofol is 490,000 mg/L, which is more than 100 times less.

EPA standard method 413.2 was used to analyze oil and grease in the treated water. The oil and grease in the clear filtrate is approximately 1 mg/L.

### EXAMPLE 3

Regular Milk

To 100 mL of undiluted regular milk (Albertson's Homogenized Milk), 3 grams of KAl(SO₄)₂ is added. The pH of the milk after addition will change from 6.72 to 3.52. Slowly add 1 gram of NaHCO₃ while stirring; phase separation starts when the aluminum hydroxide starts to precipitate. The resulting precipitates are then filtered through a No. 6 filter paper. The Turbidity of the final filtrate is 6.1 NTU. Compared with the Turbidity of regular milk of 51,300 NTU, the turbidity is reduced by 800 times.

### EXAMPLE 4

2% Reduced Fat Milk

To 100 mL of undiluted 2% reduced fat milk (Ross Swiss), 1 gram of KAl(SO₄)₂ is added. The pH of the milk after addition will change from 6.68 to 3.56. Slowly add 1 gram of NaHCO₃ while stirring; phase separation starts when the aluminum hydroxide starts to precipitate. The resulting precipitates are then filtered through a No. 6 filter paper. The Turbidity of the final filtrate is 6 NTU. Compared with the Turbidity of regular milk of 37,300 NTU, the turbidity is reduced 6000 times.

EPA method 413.2 is used to measure oil and grease level. After treatment, oil and grease level in the 2% fat milk is reduced to 7 mg/L.

### EXAMPLE 5

Fat Free Milk

To 100 mL. of undiluted free milk (Ross Swiss), 2 gram of KAl(SO₄)₂ is added. The pH of the milk after addition will change from 5.57 to 3.72. Slowly add 1 gram of NaHCO₃ while stirring; phase separation starts when the aluminum hydroxide starts to precipitate. The resulting precipitates are then filtered through a No. 6 filter paper. The turbidity of the final filtrate is 0.51 NTU. Compared with the Turbidity of original fate free milk of 6,2000 NTU, the turbidity reduction by this treatment is 12,000 times.

### EXAMPLE 6

Soy Milk

To a solution of 100 mL soy milk (Tan Nam), 2.5 gram of KAl(SO₄)₂ is added. The resulting pH of the solution is 3.75. Slowly add 1.5 gram of NaHCO₃ while stirring; phase separation starts when the aluminum hydroxide starts to precipitate. The resulting precipitates are then filtered through a No. 6 filter paper. The Turbidity of the final filtrate is 1.4 NTU. About 30 grams of solids remained on the filter paper. The turbidity of original soybean milk is 29,000 NTU thus Turbidity is reduced by 20,000 times.

EPA method 413.2 is used to measure oil and grease level. The oil and grease level in the soy milk is 43,000 mg/L. After treatment, oil and grease level is reduced to 10 mg/L.

### EXAMPLE 7

Ensure® Nutrition Drink

Prepare a starting solution by adding 10 grams of The Ensure® nutrition drink into 90 mL of water. And 2 grams of KAl(SO₄)₂, the resulting pH is 3.56. Slowly add 1.5 grams of NaHCO₃ while stirring; phase separation starts when the aluminum hydroxide starts to precipitate. The resulting precipitates are then filtered through a No. 6 filter paper. The Turbidity of the final filtrate is 0.27 NTU. Compared with the Turbidity of 10 times diluted ensure solution of 99,500 NTU, the turbidity reduction by this treatment is 300,000 times.

Zeta Potential Analysis

Zeta potential is a measure of dispersion stability of a colloid solution. Higher zeta potential implies a more stable dispersion while low values indicate colloid instability. Negative zeta potential indicates that the colloid is negatively charged and vise versa. Since all of the above example are colloid solutions, their zeta potentials are measured using Zetasizer 3000HS (Malvern Instrument, Inc.) as listed below:

| | Zeta Potential (mV): |
|---|---|
| Propofol | −49.9 |
| Regular milk | −37.9 |
| 2% Reduced milk | −35.6 |
| Fat free milk | −31.3 |
| Soy milk | −22.1 |
| Ensure | −28.7 |

As shown from the above table, the tested emulsions are all negatively charged colloid suspension. Soy milk has the lowest absolute value of zeta potential and thus has the lowest stability in the suspension, Propofol has the highest absolute value of zeta potential and thus is most stable in the suspension. Since this invention uses a co-precipitation process, it is expected that positively charged colloid suspensions can also be treated by the inventive process.

Conclusion

Potassium aluminum sulfate has been proved to be very efficient in removing oil particles in the emulsion solution. This invention separates the water phase from the oily emulsion particles and maintains the compounds in the oily emulsion particles within the precipitation.

While the invention has been described in complete detail and pictorially shown in the accompanying drawings it is not to be limited to such details, since many changes and modifications may be made in the invention without departing from the spirit and scope thereof. Hence, it is described to cover any and all modifications and forms which may come within the language and scope of the appended claims.

1. A process for removing an oil-in-water emulsion from waste water that results from the production of a water-based product, said process comprising the following steps:
a) collect the emulsion waste water in a container,
b) add a quantity of a precipitation reagent with trivalent cations,
c) add a quantity of a base compound to adjust the pH of the waste water to approximately 6.5, which converts the trivalent cations to a gelatinous cation hydroxide precipitation and separates the emulsion from the waste water, and
d) separate the precipitation from the waste water by utilizing a filtration means.

2. The process as specified in claim 1 wherein said emulsion is comprised of positively or negatively charged colloids, such as pharmaceutical drugs and dairy products.

3. The process as specified in claim 1 wherein said quantity of a precipitation reagent is comprised of a trivalent compound.

4. The process as specified in claim 3 wherein said trivalent compound is comprised of potassium aluminum sulfate.

5. The process as specified in claim 3 wherein said trivalent compound is comprised of aluminum chloride.

6. The process as specified in claim 3 wherein said trivalent compound is comprised of ferric chloride.

7. The process as specified in claim 1 wherein said base compound is comprised of sodium bicarbonate.

8. The process as specified in claim 1 wherein said base compound is comprised of sodium carbonate.

9. The process as specified in claim 1 wherein said base compound is comprised of ammonia.

10. The process as specified in claim 1 wherein said base compound is comprised of sodium hydroxide.

11. The process as specified in claim 1 wherein said filtration means is comprised of vacuum filtration.

12. The process as specified in claim 1 wherein said filtration means is comprised of positive pressure filtration.

13. The process as specified in claim 1 wherein said filtration means is comprised of a centrifuge.
